(19) United States
(12) Patent Application Publication
(10) Pub. No.: US 2020/0258071 A1
(43) Pub. Date: Aug. 13, 2020

(54) MEDIA ASSET GENERATION AND DATA PROCESSING BASED ON LOCATION AND MEDIA ASSET TYPE PATTERNS

(71) Applicant: PSI SYSTEM, INC., El Segundo, CA (US)

(72) Inventor: Harry T. WHITEHOUSE, Portola Valley, CA (US)

(21) Appl. No.: 16/859,844

(22) Filed: Apr. 27, 2020

Related U.S. Application Data
(63) Continuation of application No. 13/651,091, filed on Oct. 12, 2012.
(60) Provisional application No. 61/547,556, filed on Oct. 14, 2011.

(51) Int. Cl. G06Q 20/22; G06Q 10/08

(52) U.S. Cl. CPC G06Q 20/22; G06Q 20/3276; G06Q 10/083

(57) ABSTRACT

In some embodiments, pattern recognition may be performed on a physical object. Based on the pattern recognition, a media asset type associated with the physical object may be detected. Based on the detection of the media asset type, one or more type-specific media assets associated with the media asset type may be generated and presented on a display of a user device. Input data corresponding to at least one of the type-specific media assets may be obtained via one or more input fields of the type-specific media assets. The input data may be transmitted to a remote computer system via one or more computer networks.

### CROSS-REFERENCE TO RELATED APPLICATIONS

This application is a continuation of U.S. patent application Ser. No. 13/651,091, filed Oct. 12, 2012, which claims the benefit of U.S. Provisional Application No. 61/547,556, filed Oct. 14, 2011, each of which is hereby incorporated by reference herein in its entirety.

### FIELD OF THE INVENTION

This invention relates to generation of media assets and data processing in response to the media assets, including, for example, generation and presentation of media assets based on a media asset type associated with an object in transit or provided to a recipient.

### BACKGROUND OF THE INVENTION

While credit cards, PayPal and other forms of electronic payment dominate today's commercial scene, a significant number of merchants still use the model of “Collect on Delivery” or COD, i.e., collect payment upon delivery of an item to its intended recipient. As shown in FIGS. 1-5, the USPS COD form 3816 is a five-part carbon form which must be filled out by hand or a pin-feed impact printer. FIG. 1 shows a layout of the first copy (delivery unit copy or Copy 1). This copy is removed by the delivery USPS employee at time of delivery of the item. FIG. 2 shows a layout of the second copy (payment copy or Copy 2) that is also removed by the delivery USPS employee at time of delivery of the item. FIG. 3 shows a layout of the third copy (matter copy or Copy 3) that is retained by the recipient of the item. FIG. 4 shows a layout of the fourth copy (Mailing Post Office copy or Copy 4) that is retained by the mailing post office. FIG. 5 shows a layout of the fifth copy (Addressee copy or Copy 5) that is retained by the addressee or recipient of the item. Some merchants produce thousands of these forms per day, often shipping various products, such as vitamin supplements, which arrive on a recurring “subscription” basis.

From the merchants' standpoint, they must prepare the onerous multi-part (multi-copy) carbon USPS form 3816 by using increasingly rare pin-feed impact printers or fill in the USPS form 3816 by hand. In many cases, the product being shipped will also have another shipping label, perhaps with an independent tracking barcode, so there is often redundancy in the labeling and the need to coordinate the identification number of the COD form provided at the top right of the first copy of the USPS form 3816 (shown in FIG. 1) with the tracking number generated by another system.

### SUMMARY

In some embodiments, pattern recognition may be performed on a physical object. Based on the pattern recognition, a media asset type associated with the physical object may be detected. Based on the detection of the media asset type, one or more type-specific media assets associated with the media asset type may be generated and presented on a display of a user device. Input data corresponding to at least one of the type-specific media assets may be obtained via one or more input fields of the type-specific media assets. The input data may be transmitted to a remote computer system via one or more computer networks.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIGS. 1-5 show layouts of copies (delivery unit copy or Copy 1, payment copy or Copy 2, matter copy or Copy 3, Mailing Post Office copy or Copy 4, and Addressee copy or Copy) of a conventional collect on delivery form used by the United States Postal Service.

FIG. 6 is a schematic diagram of a system for generating the mailing label, according to one or more embodiments.

FIGS. 7A and 7B illustrate layouts of a postage label created using a postage system, according to one or more embodiments.

FIG. 8 shows an example of track and confirm message window generated by a computer controlled by the United States Postal Service.

FIG. 9 is a schematic diagram of a system for processing collect on delivery transactions, according to one or more embodiments.

### DETAILED DESCRIPTION

In some embodiments, a centralized internet-based postage system can be used to create a single ply or sheet shipping label that can be integrated with COD instructions. An example of such centralized internet-based postage system is described in U.S. Pat. No. 6,005,945 to Whitehouse, the entire content of which is incorporated herein by reference. However, the single ply or sheet shipping label can also be generated by a computer system other than the centralized internet-based postage system. For example, in one embodiment, as it will be described in following paragraphs, a client computer associated with a user or shipper can be connected to a server computer associated with a postage vendor (e.g. Endicia) or a merchant (e.g., Amazon.com, Ebay.com, etc.). The server computer associated with the postage vendor or merchant sends data to the client computer associated with the user or shipper that will enable the user or shipper to print a single ply shipping label having a tracking code including a service type code.

In the centralized internet-based postage model, rather than having independent, stand-alone electro-mechanical postage meters located throughout the country, an array of equivalent “virtual meters” is maintained in a database at a centralized server site. Each postage transaction uses a secure communication from the end user to the centralized server site. This type of system includes a centralized database of indicia and, in the case of shipping labels, associated tracking database that encompasses a whole mailing and shipping behavior of a plurality of users (e.g., hundreds of thousands of users). Another aspect of PC-based postage is the serialization of each postage indicium. Each indicium has a unique combination of account number and serial number (also referred to as “piece count” in the mailing industry).

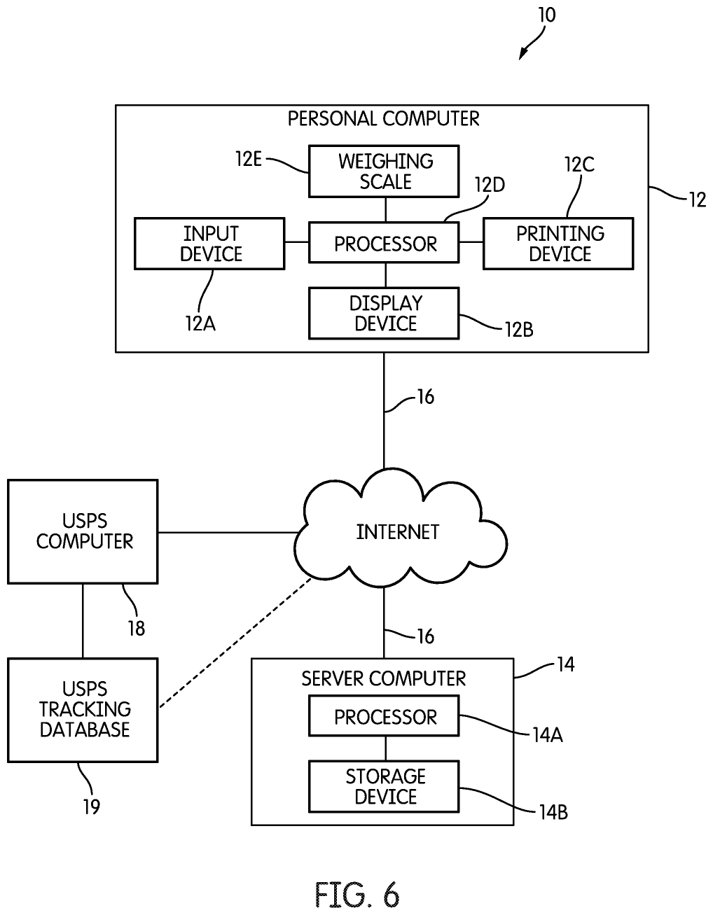

FIG. 6 is a schematic diagram of a system for generating the mailing label, according to one or more embodiments. The system 10 for generating the mailing label comprises a first computer system (e.g., a personal computer, a laptop computer, a handheld computing device, a computing tablet, etc.) 12 associated with a user or shipper and a second computer system (e.g., personal computer, a computer server, or a plurality of computers in a distributed computing environment, etc.) 14 associated with a postage vendor, such as ENDICIA or merchant such as Amazon.com, Ebay.com, etc., or entity having a business relationship with USPS that can provide a label with data including a tracking code (referred to herein as “tracking code provider”), or the USPS itself (e.g., USPS Webtool service). The first computer 12 associated with the user is connected to the second computer 14 associated with tracking code provider through a wired or wireless communication line 16, such as through the internet, an ATM network, a wide area network (WAN), local area network (LAN), cellular communication network, etc.

The first computer system 12 includes an input device 12A, a display device 12B, a printing device or printer 12C, and a processor 12D. The input device 12A, the display device 12B, and the printer 12C are in communication with processor 12D. The input device 12A can be of any type, such as a keyboard, a mouse, a trackball, a joystick, or a touch-screen type input device, or any combination thereof. The display device 12B can be of any type, for example, an LCD screen, a projection screen, or a head-mounted-display (HMD) device, or any combination thereof. For example, in the case where the input device 12A is a touch screen, the input device 12A and the display device 12B can be integrated as a same device. The printing device 12C can be any type of printer. For example, in one embodiment, the printer 12C can be a DYMO printer, from ENDICIA. In another embodiment, the printer 12C can be an ink-jet or laser printer, just for example. The printer 12C is used to output data in a printed form.

In one embodiment, the first computer system 12 may optionally further include a weighing scale 12E for weighing the package to measure its weight for proper mail rate evaluation. The weighing scale 12E can be used by the user to weigh the package to be shipped to calculate appropriate postage.

The second computer 14 associated with the tracking code provider includes one or more processors 14A and one or more storage devices 14B. The one or more storage devices 14B store accounts and various other information of the users. In one embodiment, a user desiring to print postage or a label with indicia having a certain postage value sends a request to second computer (e.g., computer server) 14 using first computer (e.g., personal computer) 12 via communication line 16. If sufficient funds are available in the user's account or if the user has certain account privileges with the tracking code provider or postage vendor, the request is granted by the second computer 14 by sending a message to first computer 12. At which point, the user can use printer 12C to print the postage label with the postage value indicium if requested, the tracking code, and any other information such as the destination address, etc. In other embodiments, printing a postage value on the label may not be needed, for example in a situation where postage stamps are used instead of the printed postage value indicium. In this case, a user desiring to print a label with a tracking code sends a request to second computer (e.g., computer server) 14 using first computer (e.g., personal computer) 12 via communication line 16. The second computer 14 then sends a message or data including the tracking code to first computer 12 allowing the user to use printer 12C to print the postage label with the tracking code and any other information such as the destination address, zip code, etc., if requested.

In one embodiment, the second computer 14 associated with the tracking code provider or postage vendor computes a cost of mailing the package and provides the cost to computer 12 associated with the user or shipper. The shipper can pay for the cost of mailing the package using a credit card or using an account set up with the tracking code provider. In one embodiment, if the mail label is intended for shipping a collect on delivery item or package, the tracking code provider or postage vendor can compute the cost of mailing by adding a postage fee amount to a collect on delivery (COD) fee that is based on a collect on delivery amount of the item. The COD fee can be, for example, set as a percentage rate of COD amount or set as a fixed-step fee depending on the COD amount, etc.

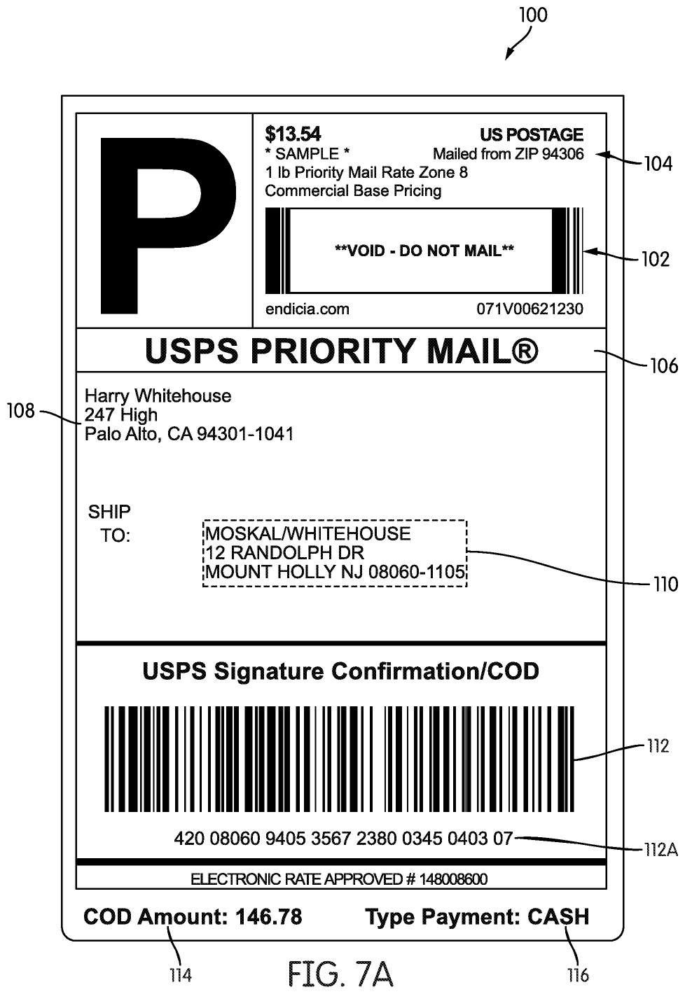

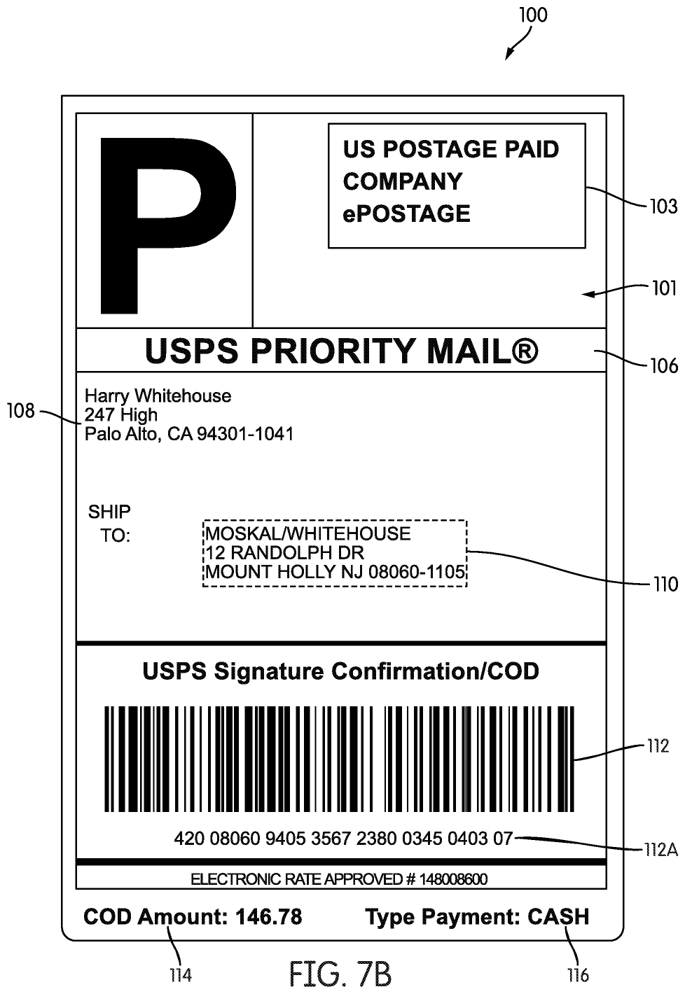

FIGS. 7A and 7B illustrate a layout of a postage label 100 created using system 10, according to one or more embodiments. In one embodiment, as shown in FIG. 7A, the label 100 contains the digital postage value indicium 102 and information about the originating mailer at 104. In one embodiment, the postage value indicium 102 comprises a two-dimensional (2D) barcode. However, as it can be appreciated, the postage value indicium 102 may have any other form. In another embodiment, the postage value indicium 102 may even be replaced by a space reserved for applying postage stamps. In yet another embodiment, as depicted in FIG. 7B, a space 101 reserved for the postage value indicium 102 can be used to indicate that postage is not needed such as “US POSTAGE PAID” at 103 when the postage is pre-paid (e.g., used in USPS ePOSTAGE, the USPS Electronic Verification System or EVS Program, or the USPS Permit-Based Manifest System). Thus, as it can be appreciated, the use of an Information-Based-Indicia (IBI) postage mark is not required in the present disclosure. The present disclosure simply requires that the shipping or mail label includes a tracking code (e.g., a tracking barcode) having an appropriate service code for a collect on delivery service. At 106 is shown the class of mail selected for label 100, for example, Priority Mail®. However, any other class of mail can be used such as Express Mail®, Parcel®, First Class®, etc. The return address, i.e., the shipper's address is displayed at 108. The destination or recipient address is shown at 110.

A tracking barcode 112 is also provided on label 100. The tracking barcode 112 may be printed along its associated tracking number 112A. In one embodiment, the tracking barcode 112 is a one-dimensional (1D) barcode, as shown in FIGS. 7A and 7B. However, any other type of tracking barcode can be used such as a 2D barcode, for example. In one embodiment, the tracking barcode 112 and/or tracking number 112A may contain the following information:

1. Destination ZIPS: the 5-digit ZIP code of the destination

2. Channel Application Identifier: A two-digit code that indicates the type of postage payment

3. Service Code: A three-digit field that identifies the type of service requested (e.g. COD, Registered, etc.). For example, the three-digit service code 053 indicates that this is a Priority Mail package with a COD service.

4. Source Identifier

5. Mailer ID: A six-digit field that identifies the shipper (e.g., merchant)

6. Unique Serial Number: An eight-digit field which uniquely identifies a mail piece associated with the label within those mailed using the Mailer ID.

In one embodiment, the barcode 112 follows the general barcode specification implemented by USPS. The general 1D barcode specification as published by the USPS Publication 91 Addendum for Intelligent Mail™ package barcode (IMpb) and 3-digit Service Type Code, Version 1.5 dated October 2010 (incorporated herein by reference in its entirety) is as shown in Table 1. For example, the service code of 053 (as well as other possible COD combinations) defined by the USPS is shown in Appendix I of the aforementioned document.

TABLE 1
Format N01 Online Label Format (6-digit
Mailer ID, 5-digit routing ZIP code)

| Date Field | Field Length | |
|---|---|---|
| “420” Postal Routing Code Application Identifier | 3 | digits |
| 5-digit Destination ZIP | 5 | digits |
| “94” Channel Application Identifier | 2 | digits |
| Service Type Code | 3 | digits |
| Source Identifier | 2 | digits |
| Mailer ID/Source-Defined | 6 | digits |
| Serial Number | 8 | digits |
| Mod 10 Check Digit | 1 | digits |
| Total | 30 | digits |

The postage label 100 further includes the COD amount (e.g., $146.78) indicated at 114 and printed at the bottom of the postage label 100. The postage label 100 may also indicate at 116 the type of payment that the carrier is supposed to take upon delivery of the mail item. For example, as shown in FIGS. 7A and 7B, the type of payment indicates “CASH” implying that the carrier is supposed to collect cash upon delivery of the mail item. However, as it can be appreciated, any other form of payment can be used such as check, etc.

In one embodiment, one or more carrier scanners may be configured to capture data at delivery or collection. System 10 can be configured to use existing Web-based package tracking systems (such as offered on USPS.com website) to provide visibility to the recipient and shipper; i.e., to enable the recipient or sender to track the package or mail item. System 10 may further be provided with a centralized funds management computer system or postal tracking system computer 18 that can be operated by USPS. The USPS computer 18 can communicate with postage vendor computer 14 through the internet. The USPS computer 18 is also in communication with a USPS postal tracking database 19 directly or via the internet, i.e., the USPS database 19 is in communication with USPS computer 18. By using USPS computer 18 and the postage tracking database 19, the need for individual carriers to mail funds back to merchants for every COD delivery can be eliminated. The amount collected at delivery of the mailed item is stored in the tracking database 19. As a result, the database 19 stores information such as the sender of the mail item, the recipient of the mail item, and the amount of funds collected, and optionally, the type of payment, the date and time of delivery, signature of the recipient, etc.

The tracking barcode 112 is scanned by the postal carrier at delivery. For example, handheld scanners may be configured to enable the carriers to scan the information in tracking barcode 112 on label 100. The scanner may be configured such that, upon scanning the barcode 112, different prompting sequences can be launched. In one embodiment, when a COD service code is detected in tracking barcode 112, the following information is requested of the USPS carrier:

1. The amount of funds actually collected.

2. The type of funds (cash or check)

3. The name of the person receiving the package.

4. Optionally, the signature of the recipient is captured.

Upon prompted by the scanning device that the item mailed has a COD service code and that funds are needed, the USPS carrier can check the label 100 at 114 to determine the COD amount needed to collect when handing the mail item or package to the recipient. The USPS carrier may also check the mailing label 100 at 116 to determine the form of funds to be collected from the recipient of the mail item or package. The above information when collected by the carrier is input and stored in the scanner along with the delivery date and time (for example, automatically recorded at the instant of scan). In one embodiment, the collected information is stored until the carrier returns to the Post Office where the information can be downloaded to a postal service computer. In another embodiment, the scanners may be configured to upload or transfer the collected information to the postal tracking database 19 in real time via commercial data networks, for example, wirelessly using already existing cellular network. The collected information and amount of funds collected are sent to USPS computer 18 and are stored in the Postal tracking database 19.

By using this system, the individual carrier is not responsible for mailing the funds to the merchant sender. Rather, the individual carrier can simply deposit all the COD funds collected during his/her route in the account of the local Post Office responsible for delivery. An electronic manifest justifying the total deposit will be provided by the data in the postal tracking database 19. In this embodiment, however, personal checks must be made out to the USPS, rather than the originating shipper/merchant, so that the funds can be deposited at the Post Office responsible for the delivery. However, in this scenario, the participating merchant would agree to indemnify the USPS for any losses due to returned checks.

The centralized computer 18 operated by the USPS monitors all COD collection accomplished in a given time period (e.g., a day) and transfers funds to the participating merchants. Since the centralized USPS computer 18 is handling all COD payments, receipts for a given merchant can be consolidated. As a result, a single check for one or more transactions (with an accompanying manifest) can be mailed to the merchant or the sum for the one or more transactions wire-transferred to the merchant (with an associated electronic manifest). The latter approach may also enable the merchant to use a computer system to reconcile all COD income. Indeed, because the amount collected at delivery of the mailed item associated with each sender or merchant is stored in the tracking database 19, each merchant or sender may be able to aggregate all collected funds associated its CODs.

In the conventional COD system, the recipient has a record of his payment only by keeping one of the copies of the COD form set, as explained in the above paragraphs. In contrast, with respect to embodiments described herein, the recipient obtains both the label, the goods, and an electronic record of payment on the USPS tracking system.

In some embodiments, the merchant can prepare various shipments using for example PC-based shipping label system 12. The merchant can print single ply or sheet labels, such as shipping label 100, on general purpose printers or high-speed thermal printers, or the like. The COD collection criteria can be automatically populated onto the label and also stored in electronic form. The data is conveniently indexed in the unique tracking number 112A associated with tracking barcode 112. These features may further stimulate increased use of the COD protocol.

Through the use of the embodiments described herein, USPS delivery events benefit from a faster process which eliminates filling out conventional COD forms by hand and storing the paperwork in the carrier's pocket. According to one or more embodiments, the carrier simply collects cash, checks or enters or scans a credit card number, duly noting the amount and type of payment in his hand-held scanning device. When the carrier returns to the post office, the carrier can simply turn over the grand total of all monies collected to the financial officer of the Post Office. The financial officer can extract or download from the handheld scanner a detailed manifest of all COD events for that carrier's route (as each delivery address in the USA has a unique carrier route number assigned to it) via the data collected by the USPS tracking system. The recipient benefits from a simplified and more streamlined delivery process.

The conventional five-part carbon COD form contains the return and delivery addresses, the amount of funds to be collected, the form (cash or check), the mailing date, and a unique tracking number. As described above, at delivery, the carrier makes a written note of the blocks at the bottom of the first copy (Copy 1) (delivered by, date delivered, check number) and the customer signs indicating that the goods have been received.

According to one or more embodiments, the “delivered by” field is replaced by an embedded ID of the carrier's scanning device. The “date delivered” would be similarly recorded by the scanning device as the barcode is scanned. The amount collected (and check number if applicable) would be prompted on the scanning device to be keyed in by the carrier.

Current USPS scanning devices do not accept signature images. For deliveries requiring recipient's signature such as “Signature Confirmation”, “Certified Mail”, and COD, the customer will sign a small stand-alone form carried by the carrier. This standalone form is scanned when the carrier returns to the Post Office to associate the signature with the tracking number. However, new scanning devices (such as scanning devices used by FedEx® and UPS(1D) are able to accept a signature directly on the scanning device.

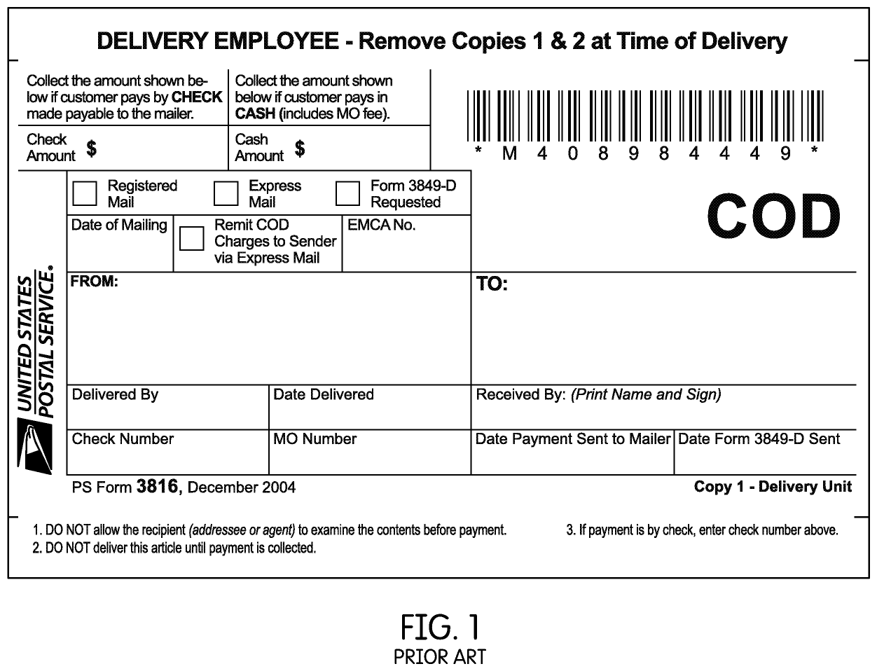

Therefore, according to an embodiment of the invention, all of the information on Copy 1 (shown in FIG. 1) are electronically available to the USPS Package Tracking System (PTS) or USPS computer 18 after the delivery event. USPS PTS computer 18 will have most of the information prior to delivery (for example, captured when the label is first printed). For example, the data printed on the postage label 100 can be communicated by the postage vendor computer 14 to the USPS computer 18. Upon delivery, data collected at the delivery event can be added to the already captured information (e.g., captured when the postage label 100 is printed).

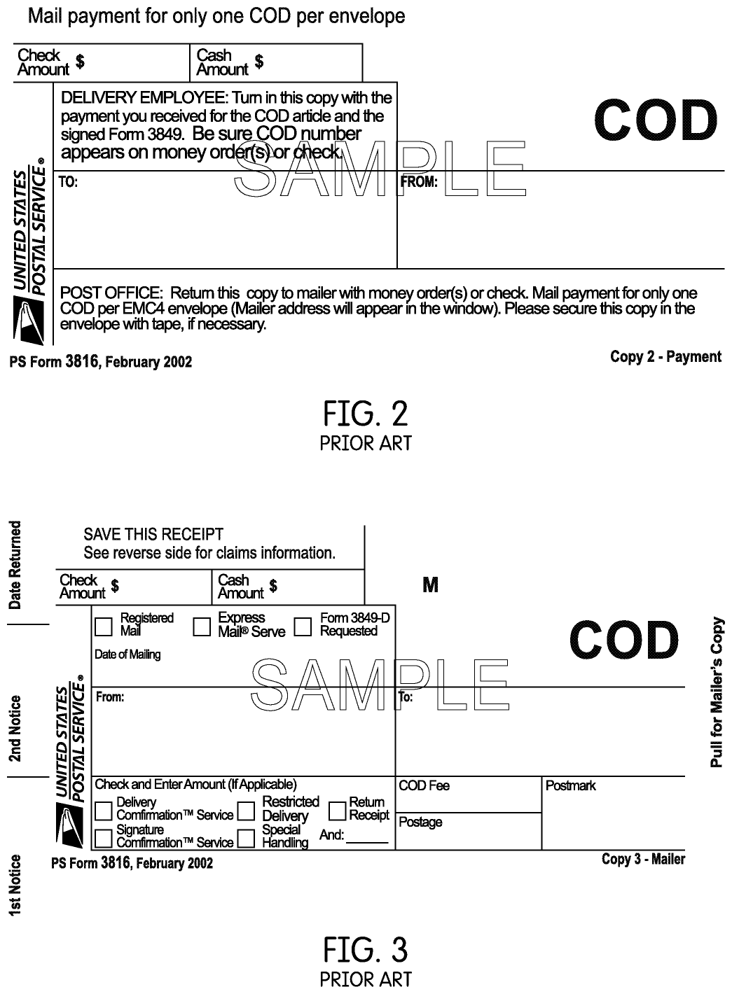

The second copy (Copy 2) of the conventional COD form, shown in FIG. 2, is conventionally used in a windowed envelope to mail back the check or money order (created in the case that cash is collected) to the shipper or merchant. In contrast, according to one or more embodiments, this second copy (Copy 2) will no longer be used as the mailing of funds in a form of a USPS check, for example, to the shipper or merchant is no longer handled by the post office associated with the delivery carrier. According to an embodiment of the invention, the payments are instead handled by the central USPS computer 18 based on data collected by USPS tracking database 19.

In the conventional COD form, the third copy (Copy 3), shown in FIG. 3, is a receipt to be kept by the mailer. In contrast, according to one or more embodiments, the third copy is also not used. A complete record of the transaction is available to the mailer or shipper in electronic form in a local memory of personal computer 12 as well as in the storage device 14B within the server computer 14 of the tracking code provider.

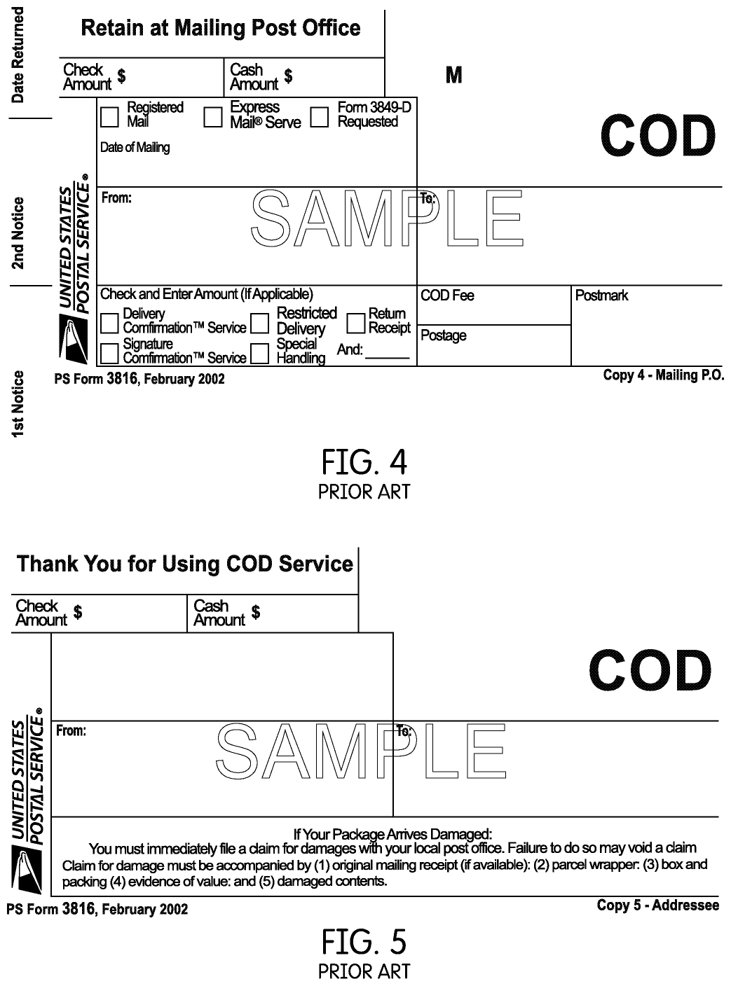

In the conventional COD form, the fourth copy (Copy 4), shown in FIG. 4, is kept by the mailing or induction post office (PO). The induction PO also stamps this form with the date of induction. In contrast, according to one or more embodiments, the fourth copy is also not used as it is redundant and unnecessary because the tracking barcode (e.g., 1D barcode) is also scanned at acceptance and this event is upload or transferred to the USPS PTS computer 18.

In the conventional COD form, the fifth copy (Copy 5) shown in FIG. 5, is affixed to the package and thus left with the recipient at delivery. The information on the fifth copy is contained in the shipping label 100 shown in FIG. 7. Thus, the shipping label 100 takes the place of the fifth copy (Copy 5).

Therefore, according one or more embodiments, the five parts carbon USPS COD form 3816 can be replaced with a single ply or sheet label and electronic recordation of key events.

In the following paragraphs, the USPS Package Tracking System (PTS) computer 18 is described further in detail. When a mailing label such as mailing label 100 is printed by a shipper using postage computer system 12, all of the relevant data such as, destination address, return address, weight, postage amount, class of mail, contents, special services (e.g., COD), etc., are transmitted to the postage provider server computer 14. For example, every evening, this information is uploaded by the postage provider server 14 to the USPS computer 18. There are various ways to upload the information. However, the result is that the USPS has complete information about any shipping label printed by the end of the day upon which it was printed. Each record in the USPS PTS computer 18 is indexed based on a unique tracking number.

The USPS has scanning stations spread throughout their operations. Some require an active scan by a human, others are so-called passive scans done in the mail processing plants. Each scan is reported to the package tracking system (PTS) computer 18 via the USPS network.

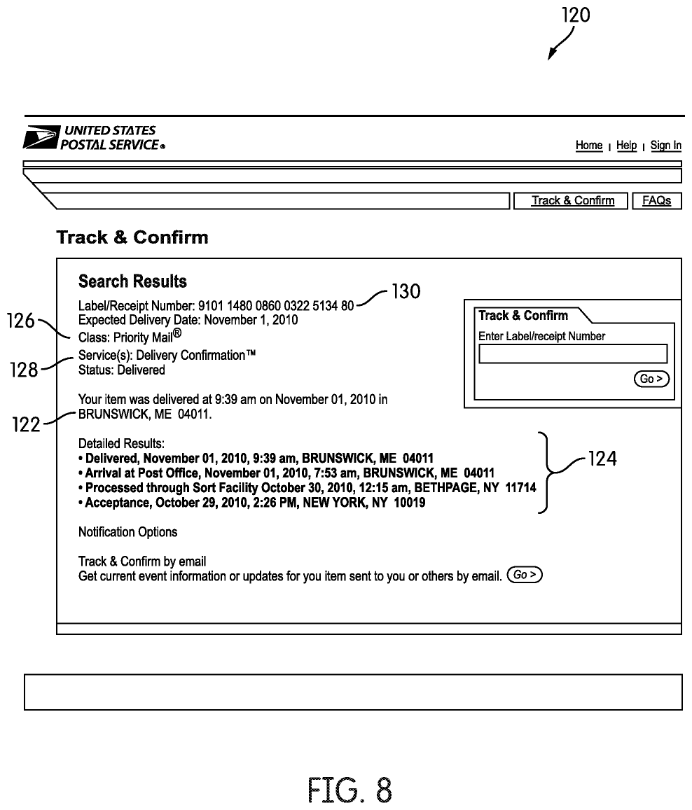

FIG. 8 shows an example of track and confirm message window 120 generated by the USPS PTS computer 18. For example, as shown in confirm message window 120, the package is inducted in New York City, N.Y. on Oct. 29, 2010 at 2:26 PM, as shown at 122. The package is scanned numerous times and is finally delivered by a carrier on Nov. 1, 2010 at 9:39 AM, as shown at 124. This particular package is shipped using Priority Mail, as indicated at 126. A delivery confirmation service is requested by the shipper, as indicated at 128. The message window 120 also shows the receipt or tracking number associated with the shipping label (e.g., shipping label 100) on the shipped package, as indicated at 130.

The carrier or carriers, during the process of delivering the package, uses a hand-held scanner to record the position or status of the package during transit up to the delivery event. When the carrier returns to the post office at the end of his/her route, the scanner is cradled or linked to the post office computer and then all the delivery data are uploaded or transferred to USPS PTS computer 18.

According to one or more embodiments, one or more carrier scanners may be configured such that if a tracking number with a service code indicating COD (e.g., 053) is detected or read, a subsequent screen pops up so that the carrier can input the amount collected and record whether it is cash, check, or credit card, for example. Another method of funds collection that can be implemented is by using near field technology to transfer funds from a recipient's mobile phone to the postal carrier scanning device. Subsequently, when the carrier is back at the post office, the COD related data can also data be uploaded to the PTS system in the same manner described above.

In one embodiment, the USPS tracking database 19 is also updated or upgraded to add two new columns. The amount of funds collected is reported on a first column and the means of payment (i.e., checks, cash or credit card) is reported on a second column. This information may be available to the shipper, the recipient, and employees of the USPS.

In one embodiment, at the end of each day, every two days, every half-a-day, or other time period, reports can be run against the USPS tracking database 19 for all COD collection events. In one embodiment, the reports can be aggregated by shipper ID. The shipper ID can be either inferred from the return address or the Mailer ID embedded in the tracking barcode 112. This type of aggregation would allow the USPS to compute all COD collections for a designated shipper, i.e., Merchant A. There may be a plurality of COD collections associated with each shipper. In this case, instead of sending separate payments for each COD collection to the shipper, the USPS may aggregate the COD collections associated with the shipper produced in a given period of time (e.g., one day) and send a single payment to the shipper. The USPS may also aggregate each code collection to the shipper from multiple delivery locations nationwide. In one embodiment, the payment can be accompanied by a manifest of COD events involved in that lump sum payment indicating an amount of funds collected, type of funds collected, and recipient address for each COD event during the given time period (e.g., one day). In this way, a single USPS office can manage all COD payments to the shippers as opposed to having this process spread out to hundreds or thousands of carriers and post offices. Similarly, as stated in the above paragraphs, because the amount collected at delivery of the mailed item associated with each sender or merchant is stored in the tracking database 19, each merchant or sender may be able to aggregate all collected funds associated its CODs.

Similarly, in one embodiment, the USPS tracking database 19 can be used by the finance office at the delivery post office. A large post office might have 50 carriers delivering mail. Perhaps, on a given day, there may be 100 COD events for all the 50 carriers. The USPS PTS computer 18 can provide the anticipated COD events for the day broken out by carrier route number (as each delivery address has a unique carrier route ID associated with it). At the end of the day, the finance officer may use these reports to ensure that the monies received match that anticipated by the data. If discrepancies are found, the discrepancies are noted for further verification or control.

The conventional USPS COD procedure requires that checks be written to the merchant or shipper. It is the delivery carrier's responsibility to mail the collected check to the merchant using the second copy (Copy 2) of the conventional USPS COD form set and a special windowed envelope.

Instead, in one embodiment, a check for collected amount of money is made out to the USPS so that the check can simply be deposited into the general account at the delivery post office. As stated in the above paragraphs, the merchant may enter into an agreement with the USPS to indemnify the USPS against returned checks.

In another embodiment, alternatively, the checks can be made out to the shipper or merchant. In this case, the data stored in the USPS tracking database 19 can be used for handling the check. For example, every evening, a post office employee can run a report on COD events that occurred during the day. The post office employee may then use that report to automatically print out labels addressed to the merchants. The labels would contain the merchants address, the amount collected and the associated tracking number. For example, these labels could be used in conjunction with G10 USPS Official Mail envelopes to return the checks to the merchants. In other words, the functionality of Copy 2 would be replaced by invoking a reporting function based on the USPS tracking database 19 and the COD's processed that day by the Post Office in question.

In one embodiment, a merchant may offer various methods of payment for customers. For example, the merchant may offer to pay for items to be shipped by credit card, PAYPAL™ Google Checkout™, or USPS COD. If the effective COD rate is comparable or lower than other means of payments (e.g., credit card, PAYPAL™, Google Checkout™, etc.), the customer may be attracted to select USPS COD as a method of payment. As a result, USPS may be able to gain shipping business because of a lower cost for funds collection offered to the merchant. For example, if a credit card charges a certain percentage of the price of an item as processing fees on each transaction (e.g., approximately 1% to 2%), the USPS may be able to be competitive in offering a lower percentage rate for transaction fees on the same transaction (e.g. less than approximately 1%).

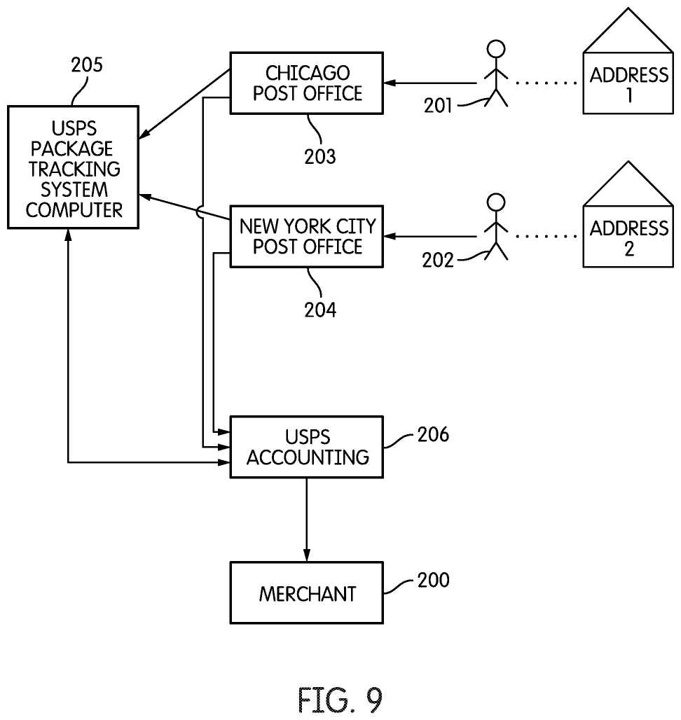

FIG. 9 is a schematic diagram of a system for processing collect on delivery transactions, according to one or more embodiments. FIG. 9 illustrates an example of flow of funds in a collect on delivery process. For example, a single merchant 200 ships two COD packages. One package is shipped to an address in Chicago (Address 1) and the other package is shipped to an address in New York City (Address 2). For example, the two COD packages are coincidently delivered on the same day. A postal carrier 201 in Chicago delivers one package to Address 1 and scans the tracking barcode on a mail label on the package using a scanning device and enters the amount of funds collected at delivery into the scanning device. Similarly, a postal carrier 202 in New York City delivers one package to Address 2 and scans the tracking barcode on a mail label on the package using a scanning device and enters the amount of COD funds collected at delivery into the scanning device. The postal carriers 201 and 202 return to their affiliated post offices 203 and 204, respectively, at the end of their route. At their respective post offices 203, 204, the postal carriers 201 and 202 can, for example, cradle their scanning devices to transfer the delivery information to the USPS Package Tracking System (PTS) computer 205. The postal carriers 201 and 202 simply deposit the COD funds into local coffers of their respective post offices 203 and 204. An electronic notification of the COD funds collection is sent to a USPS Accounting Office 206 or another USPS entity by the USPS PTS computer 205 and/or by each post office 203 and 204. The USPS Accounting Office 206 (or another USPS entity) then runs a delivery report against the Package Tracking System computer 205 seeking all COD deliveries made that day, and groups the COD deliveries by merchant. The USPS Accounting Office 206 determines the COD deliveries originating from the merchant 200. The USPS accounting office then makes a bulk transfer of funds by wire or check to the merchant 200. The merchant 200 receives the bulk of funds representing a sum of all funds collected that day on behalf of the merchant 200, i.e., in this example, equal to the sum of the COD amounts collected at delivery to Address 1 in Chicago and Address 2 in New York City.

Although the various steps of the method(s) are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A system for facilitating generation of type-specific media assets and related data processing based on one or more patterns for a location and media asset type associated with an object, the system comprising:
a handheld user device comprising a housing, a display within the housing, a short-range wireless transceiver within the housing, and one or more processors, within the housing, that are programmed with one or more computer instructions that, when executed by the one or more processors, cause the user device to:
perform pattern recognition on a physical object in transit from a start location to an end location or provided to a recipient at the end location, the physical object comprising one or more patterns indicative of a location associated with the physical object and a media asset type associated with the physical object;
detect, based on the pattern recognition, the media asset type associated with the physical object;
generate, based on the detection of the media asset type, type-specific media assets associated with the media asset type and present the type-specific media assets on the display of the user device, wherein the type-specific media assets comprises location-related content associated with the physical object;
initiate, based on the detection of the media asset type, a short-range wireless communication session between the user device and another user device via the short-range wireless transceiver;
obtain, from the other user device via the short-range wireless communication session, input data corresponding to at least one of the type-specific media assets; and
transmit the input data to a remote computer system via one or more computer networks.

2. The system of claim 1, wherein the user device is caused to:
obtain additional input data corresponding to at least one of the type-specific media assets via one or more input fields of the type-specific media assets; and
transmit the additional input data to the remote computer system via one or more computer networks.

3. The system of claim 1, wherein the user device is caused to:
determine, based on a sequence associated with the type-specific media assets, a first media asset from among the type-specific media assets to be presented prior to another media asset of the type-specific media assets,
wherein, subsequent the detection of the media asset type, the first media asset is presented on the display of the user device prior to the other media asset being presented on the display of the user device.

4. A method comprising:
performing, by one or more processors, pattern recognition on a physical object;
detecting, by one or more processors, based on the pattern recognition, a media asset type associated with the physical object;
generating, by one or more processors, based on the detection of the media asset type, type-specific media assets associated with the media asset type;
presenting, by one or more processors, the type-specific media assets on a display of a user device;
obtaining, by one or more processors, input data corresponding to at least one of the type-specific media assets via one or more input fields of the type-specific media assets; and
transmitting, by one or more processors, the input data to a remote computer system via one or more computer networks.

5. The method of claim 4, further comprising:
initiating, based on the detection of the media asset type, a short-range wireless communication session between the user device and another user device;
obtaining, from the other user device via the short-range wireless communication session, additional input data corresponding to at least one of the type-specific media assets; and
transmitting the additional input data to the remote computer system via one or more computer networks.

6. The method of claim 4, further comprising:
determining, based on a sequence associated with the type-specific media assets, a first media asset from among the type-specific media assets to be presented prior to presentation of another media asset of the type-specific media assets; and
subsequent the detection of the media asset type, presenting the first media asset on the display of the user device prior to presenting the other media asset on the display of the user device.

7. The method of claim 4, wherein performing the pattern recognition on the physical object comprises performing the pattern recognition on one or more patterns affixed to the physical object.

8. The method of claim 4, wherein detecting the media asset type comprises:
obtaining, based on the pattern recognition, a tracking code associated with the physical object, the tracking code being indicative of a location associated with the physical object and the media asset type associated with the physical object; and
extracting an indication of the media asset type from the tracking code to detect the media asset type.

9. One or more computer-readable media comprising instructions that, when executed by one or more processors, cause operations comprising:
detecting, from one or more portions of a physical object, a media asset type associated with the physical object;
generating, based on the detection of the media asset type, type-specific media assets associated with the media asset type;
presenting the type-specific media assets on a display of a user device;
obtaining input data corresponding to at least one of the type-specific media assets via one or more input fields of the type-specific media assets; and
transmitting the input data to a remote computer system via one or more computer networks.

10. The media of claim 9, the operations further comprising:
initiating, based on the detection of the media asset type, a short-range wireless communication session between the user device and another user device;
obtaining, from the other user device via the short-range wireless communication session, additional input data corresponding to at least one of the type-specific media assets; and
transmitting the additional input data to the remote computer system via one or more computer networks.

11. The media of claim 9, the operations further comprising:
determining, based on a sequence associated with the type-specific media assets, a first media asset from among the type-specific media assets to be presented prior to presentation of another media asset of the type-specific media assets; and
subsequent the detection of the media asset type, presenting the first media asset on the display of the user device prior to presenting the other media asset on the display of the user device.

12. The media of claim 9, further comprising:
performing pattern recognition on one or more patterns affixed to the physical object,
wherein detecting the media asset type comprises detecting the media asset type associated with the physical object based on the pattern recognition.

13. The media of claim 12, wherein detecting the media asset type comprises:
obtaining, based on the pattern recognition, a tracking code associated with the physical object, the tracking code being indicative of a location associated with the physical object and the media asset type associated with the physical object; and
extracting an indication of the media asset type from the tracking code to detect the media asset type.
